(19) United States
(12) Patent Application Publication
(10) Pub. No.: US 2020/0013547 A1
(43) Pub. Date: Jan. 9, 2020

(54) IGNITION COIL

(71) Applicant: Mitsubishi Electric Corporation, Tokyo (JP)

(72) Inventor: Takashi IDOGAWA, Tokyo (JP)

(73) Assignee: Mitsubishi Electric Corporation, Tokyo (JP)

(21) Appl. No.: 16/494,512

(22) PCT Filed: Mar. 30, 2017
(86) PCT No.: PCT/JP2017/013291

§ 371 Date: Sep. 16, 2019

(51) Int. Cl. H01F 38/12

(52) U.S. Cl. CPC H01F 38/12; H01F 2038/127

(57) ABSTRACT

Obtain an ignition coil in which a magnet is provided at a magnet holding portion which is formed between a first side iron core and a second side iron core, and intervening components which are configured by using a non-magnetic material, are included at facing portions which are provided at end portions of separated surfaces of the first side iron core and separated surfaces of the second side iron core, in a state where the magnet holding portion is formed by using the first side iron core and the second side iron core, and are faced at a surface which is vertical with respect to an axis direction of the side iron cores, and the intervening components have a thickness which is less than a distance between the separated surfaces of the first side iron core and the separated surfaces of the second side iron core.

### TECHNICAL FIELD

The present invention relates to an ignition coil which is attached, for example, to an internal combustion engine, and supplies a high voltage to an ignition plug so as to generate a spark electrical discharge.

### BACKGROUND ART

In an ignition coil which is used for an internal combustion engine, for example, as indicated in Patent Document 1, a primary coil and a secondary coil are wound around an outer circumference of a center iron core, and a side iron core is arranged at an outer side (one side) of the primary coil and the secondary coil, whereby a closed magnetic passage is configured. These components are housed in an insulating case which is made of a resin, and moreover, an insulating material, such as an epoxy resin, is filled in space in the insulating case, whereby an insulation capability is maintained. Moreover, in order to increase an output capability, there is an ignition coil in which a large magnet is adopted and a large magnetic bias is applied to a center iron core. However, when a large magnet is inserted, an inserting portion (a holding portion) is upsized, so that in the ignition coil which is described in Patent Document 1, a magnet is inserted in a side iron core in a state where the magnet is inclined from an axis direction of the side iron core, whereby it is inhibited that the ignition coil is upsized.

### CONVENTIONAL ART DOCUMENT

### Patent Document

Patent Document 1: Japanese Patent Publication No. 3042144

### SUMMARY OF THE INVENTION

### Problems to be Solved by the Invention

In recent years, in order to improve a fuel efficiency of an internal combustion engine, it is required that a high output capability is realized for an ignition coil, and moreover, it is also required that the ignition coil has a small size while various auxiliary machines are attached at a circumference of the ignition coil. In order to inhibit that an ignition coil is upsized, when a large magnet is inserted between side iron cores, there is a fear in which a position deviation of the side iron cores is caused (a magnet inserting portion is rotated) when the side iron cores are assembled to a center iron core, and a capability variation (a capability worsening) is caused.

The present invention has been made to solve the above-described problems, and an object of the invention is to obtain an ignition coil in which an assembly variation (a capability variation or a capability worsening, which is caused by an assembly variation) is not caused even when a large magnet is inclined so as to be arranged between the side iron cores.

### Means for Solving Problems

An ignition coil of the present invention includes a center iron core around which a primary coil and a secondary coil, which is coaxially provided at a circumference of the primary coil, are wound; and side iron cores which surround a part of a circumference of the secondary coil so as to be arranged, and form a closed magnetic passage with the center iron core; in a state where the side iron cores are composed of a first side iron core and a second side iron core, in which portions, which are faced to a portion in an axis direction of the center iron core in a state where the primary coil and the secondary coil are sandwiched, are separated in an oblique direction with respect to an axis direction of the side iron cores, and a magnet is provided at a magnet holding portion which is formed between the first side iron core and the second side iron core, which are separated; wherein facing portions, which are provided at end portions of separated surfaces of the first side iron core and at end portions of separated surfaces of the second side iron core, in a state where the magnet holding portion is formed by using the first side iron core and the second side iron core, and are faced at a surface which is vertical with respect to an axis direction of the side iron cores, and intervening components, which are provided at the facing portions and are configured by using a non-magnetic material, are included; and the intervening components have a thickness which is less than a distance between the separated surfaces of the first side iron core and the separated surfaces of the second side iron core.

### Effects of the Invention

According to an ignition coil of the present invention, surfaces, which are vertical in an axis direction, are provided at separated portions of side iron cores, whereby a rotational position deviation of the side iron cores, which is caused when the ignition coil is assembled, can be inhibited. Moreover, intervening components, which are configured by using a non-magnetic material, are provided at vertical portions of the side iron cores, whereby it can be also prevented that when the ignition coil is assembled, the side iron cores are adsorbed to each other by a magnetic force which is caused by a magnet which is arranged at a magnet holding portion which is formed at the separated portions of the side iron cores, and an assembly variation (a variation of a length of a gap) of the side iron cores can be inhibited.

### BRIEF DESCRIPTION OF THE DRAWINGS

FIG. 1 is a view which indicates an ignition coil according to Embodiment 1 of the present invention;

FIG. 2 is a cross-sectional view of the ignition coil which is indicated in FIG. 1;

FIG. 3 is a view of a magnetic circuit portion in the ignition coil which is indicated in FIG. 2;

FIG. 4 is a view which indicates an ignition coil according to Embodiment 2 of the present invention; and

FIG. 5 is a cross-sectional view of the ignition coil which is indicated in FIG. 4.

### MODE FOR CARRYING OUT THE INVENTION

Hereinafter, embodiments of an ignition coil of the present invention will be explained in reference to the drawings.

### Embodiment 1

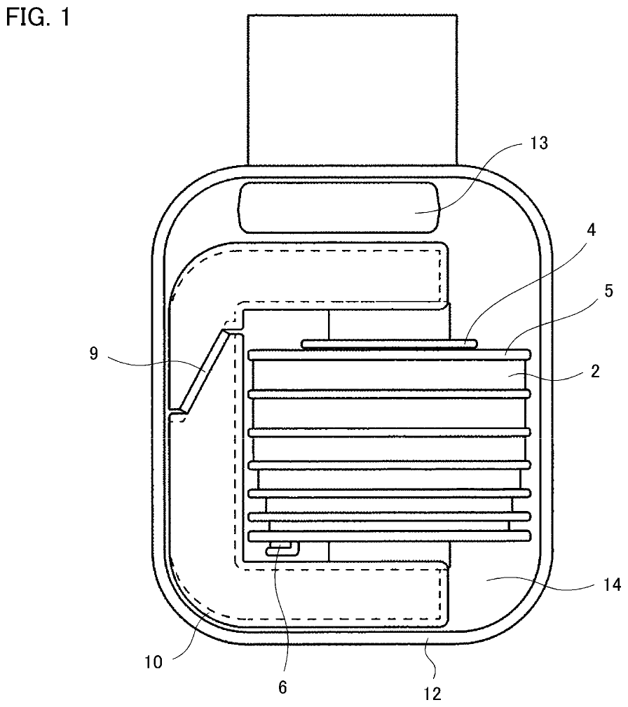

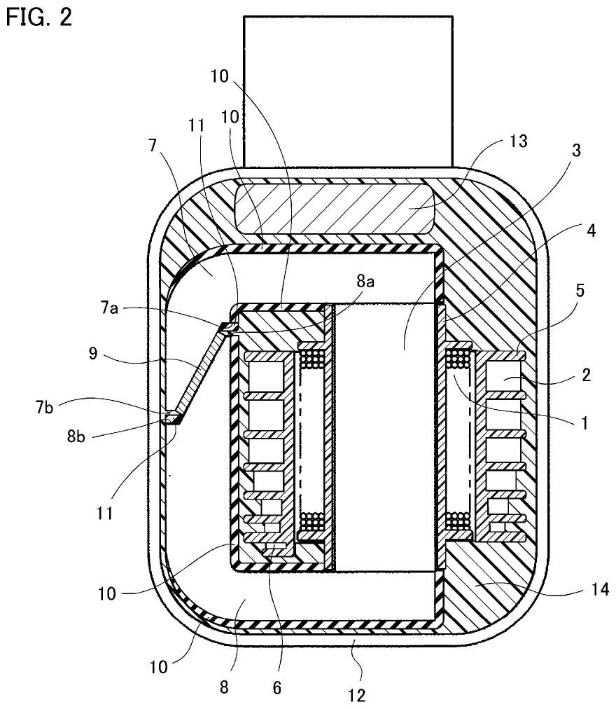

FIG. 1 is a configuration view which indicates an ignition coil according to Embodiment 1 of the present invention. Moreover, FIG. 2 is a cross-sectional view of the ignition coil which is indicated in FIG. 1.

As indicated in FIG. 1 and FIG. 2, in the ignition coil according to Embodiment 1, a primary coil 1 and a secondary coil 2 are coaxially arranged at a center iron core 3, and side iron cores, which are composed of a first side iron core 7 and a second side iron core 8 in a state where the first side iron core 7 and a second side iron core 8 are faced to the center iron core 3 so as to be separated, are arranged. In other words, the side iron cores are composed of the first side iron core 7 and the second side iron core 8, in which portions, which are faced to a portion in an axis direction of the center iron core 3 in a state where the primary coil 1 and the secondary coil 2 are sandwiched, are separated in an oblique direction with respect to an axis direction of the side iron cores. Moreover, a closed magnetic passage is formed by using the center iron core 3, the first side iron core 7, and the second side iron core 8. The primary coil 1 is wound around a primary bobbin 4, and the secondary coil 2 is wound around a secondary bobbin 5. Each of the first side iron core 7 and the second side iron core 8 is covered by using elastomers 10 in order to perform shock absorption of a thermal stress. Moreover, a magnet 9 is inclined so as to be inserted to a magnet holding portion which is formed between the side iron cores of the first side iron core 7 and the second side iron core 8, which are separated, and these components are housed in a case 12. Moreover, an integrated circuit (IC) 13, which is used for controlling, is arranged between a side surface of an inner wall of the case 12 and the first side iron core 7. In the case 12, an insulating resin 14, which is an epoxy resin which has a heat hardening characteristic, is filled so as to be hardened.

In the ignition coil which is configured as described above, the integrated circuit (IC) 13 controls an energization operation and an interruption operation of a primary electric current, which is passed through the primary coil 1, in accordance with a driving signal which is transmitted from an electronic control unit which is not illustrated. When a primary electric current, which is passed through the primary coil 1 at a predefined ignition timing of an internal combustion engine, is interrupted in accordance with the driving signal, a reverse electromotive force is generated at the primary coil 1, and a high voltage is generated at the secondary coil 2. Moreover, the high voltage, which is generated, is applied to an ignition plug, which is not illustrated, via a high-voltage terminal 6 which is arranged at a high voltage side.

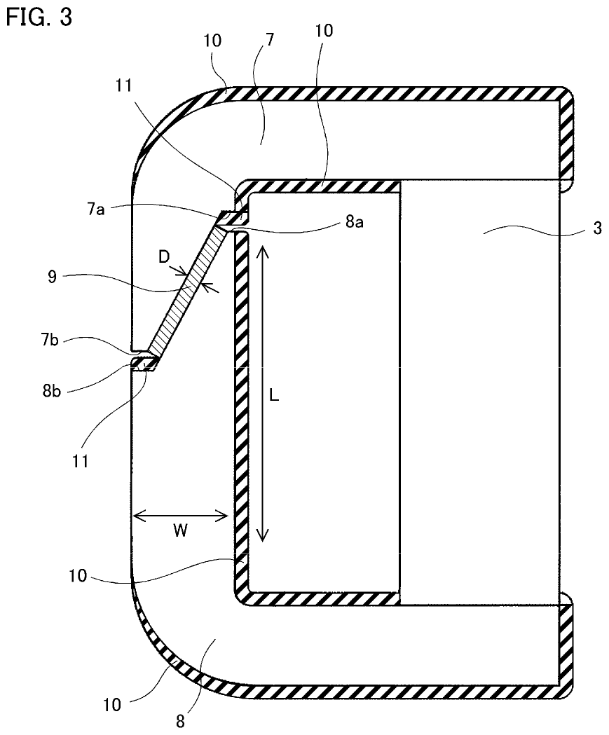

FIG. 3 indicates the first side iron core 7, the second side iron core 8, and the magnet 9 of the ignition coil, which are indicated in FIG. 2. At the first side iron core 7 and the second side iron core 8, separated surfaces 7a and 7b and separated surfaces 8a and 8b, which are vertical with respect to an axis direction (a “L” direction) of the side iron cores, are included at both of end portions in a width direction (a “W” direction) of the first side iron core 7 and the second side iron core 8, and a distance between the vertical separated surfaces is set in such a way that the distance is greater than a thickness “D” of the magnet 9 (for example in Embodiment 1, the distance is set at a 1.2-fold extent of the thickness “D” of the magnet 9), and intervening components 11, which are configured by using a non-magnetic material (the elastomers 10 are used in Embodiment 1), are arranged in such a way that the intervening components 11 occupy a distance which is greater than or equal to 50% (for example, 70% extent in Embodiment 1) of a distance between the separated surfaces 7a and 8a and the separated surfaces 7b and 8b, which are faced, of the first side iron core 7 and the second side iron core 8.

As described above, in the ignition coil according to Embodiment 1, facing portions, which are faced at the separated surfaces 7a and 7b and the separated surfaces 8a and 8b, which are vertical in an axis direction (a “L” direction) of the side iron cores, are provided at the first side iron core 7 and the second side iron core 8, and the intervening components 11 (a part of the elastomers 10 in Embodiment 1), which are configured by using a non-magnetic material, are arranged between the facing portions, whereby it can be inhibited that positions of the first side iron core 7 and the second side iron core 8, which compose the side iron cores, are deviated (the first side iron core 7 and the second side iron core 8 are rotated) when the first side iron core 7 and the second side iron core 8, which are formed as the side iron cores, are assembled to the center iron core 3.

Moreover, a thickness of the intervening components 11, which are configured by using a non-magnetic material, is greater than or equal to 50% of a distance between the side iron cores at the facing portions which are composed of the separated surfaces 7a and 7b of the first side iron core 7 and the separated surfaces 8a and 8b of the second side iron core 8, whereby when the first side iron core 7 and the second side iron core 8 are assembled to the center iron core 3, and when the first side iron core 7 and the second side iron core 8, which compose the side iron cores, are rotated, a distance, which is caused by a rotation of the first side iron core 7 and the second side iron core 8, between the side iron cores and the center iron core 3, is less than a distance (which is equal to a thickness of the intervening components 11) between the side iron cores, so that an adsorption force, which is acted to a gap portion which is caused among the first side iron core 7, the second side iron core 8, and the center iron core 3, is greater than an adsorption force, of the magnet holding portion, which is acted, in accordance with a magnetic force which is caused by the magnet 9, between the first side iron core 7 and the second side iron core 8.

Therefore, when an external force, which is operated when the ignition coil is assembled, is removed, the gap, which is caused among the first side iron core 7, the second side iron core 8, and the center iron core 3, is naturally closed, and the ignition coil is set at a normal assembly state. Thereby, a variation (a deviation), which is caused when the ignition coil is assembled, can be inhibited (if a gap is caused among the first side iron core 7, the second side iron core 8, and the center iron core 3 when the ignition coil is assembled, a capability of the ignition coil is lowered).

Moreover, the ignition coil has a configuration in which the intervening components 11 are not inserted to an overall portion between the vertical separated surfaces, by which the facing portions are formed, and a length of the gap can be defined by using the magnet 9, of which component accuracy is high, without using the intervening components 11 which are configured by using a non-magnetic material, of which component accuracy is low, so that a capability variation can be inhibited (when an overall portion is formed as the intervening components 11 which are configured by using a non-magnetic material, the intervening components 11 are contacted to the first side iron core 7 and the second side iron core 8 before the magnet 9 is contacted to the first side iron core 7 and the second side iron core 8 in accordance with a variation of a component, and there is a possibility in which the gap remains among the first side iron core 7, the second side iron core 8, and the magnet 9).

Moreover, a distance between the separated surfaces 7a and 7b and the separated surfaces 8a and 8b, which are vertical, is greater than a thickness of the magnet 9, whereby a magnetic force, which is generated from the magnet 9, is effectively passed through in the center iron core 3, so that the capability of the ignition coil can be improved (when a distance between the separated surfaces 7a and 7b and the separated surfaces 8a and 8b, which are vertical, is small, a magnetic flux of the magnet 9 is not passed through the center iron core 3, and is passed through space between the vertical separated surfaces, and a shortcut is performed. When a magnetic force is not passed through the center iron core 3, the capability of the ignition coil is lowered).

Moreover, the elastomers 10, which are used for performing shock absorption of an iron core stress, are used as the intervening components 11 which are configured by using a non-magnetic material, whereby the ignition coil can be configured without increasing the number of the components, and without increasing an assembly man-hour.

In addition, in the ignition coil according to Embodiment 1, although the facing portions, which are formed by using the separated surfaces 7a and 7b and the separated surfaces 8a and 8b in a state where the separated surfaces are vertical, install the intervening components 11 (a part of the elastomers 10) at only one side of the side iron cores, it is suitable that the intervening components 11 (a part of the elastomers 10) are installed at only the side iron core at the other side (at an opposite side), or are installed at both of the side iron cores. Moreover, it is suitable that the intervening components 11 are configured by using an iron core cover which covers the side iron cores.

### Embodiment 2

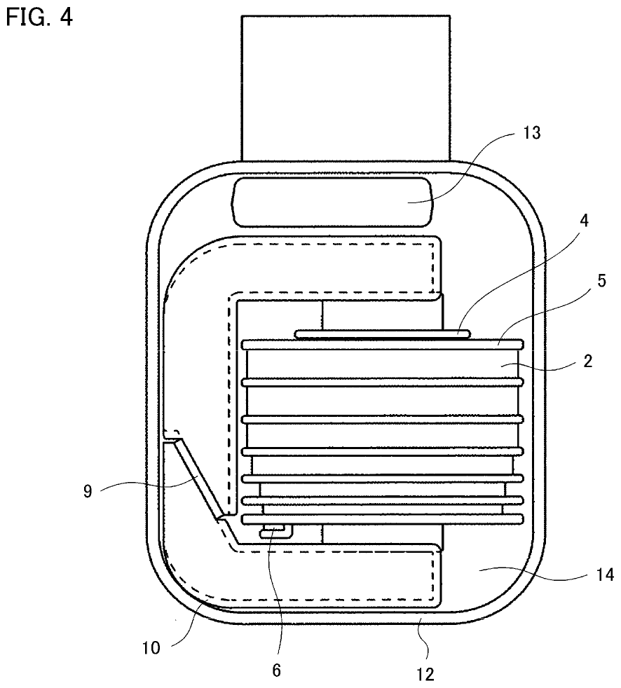

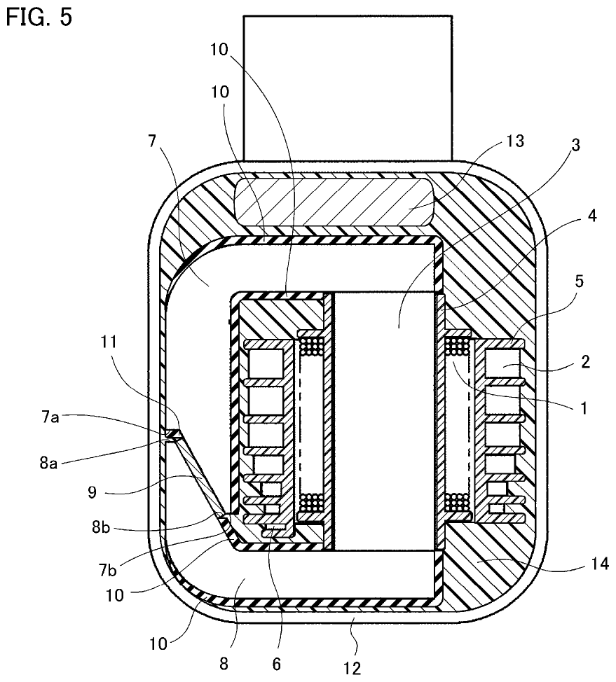

FIG. 4 is a configuration view which indicates an ignition coil according to Embodiment 2 of the present invention. Moreover, FIG. 5 is a cross-sectional view of the ignition coil which is indicated in FIG. 4.

As indicated in FIG. 4 and FIG. 5, in the ignition coil according to Embodiment 2, an insertion position of a magnet 9 is set as a high voltage side, and an intervening component 11 (a part of elastomers 10), which is configured by using a non-magnetic material, is arranged at only a case 12 side in a width direction (a “W” direction) of a first side iron core 7 and a second side iron core 8. The other configurations are similar to the configurations according to Embodiment 1.

The ignition coil according to Embodiment 2 has a configuration in which the intervening component 11 is inserted to only a high voltage side, so that an assembly variation (which is caused in accordance with a rotation of the side iron cores) can be prevented by using a similar way according to Embodiment 1.

Moreover, in the ignition coil according to Embodiment 2, the vertical separated surfaces are abolished in reference to coil sides (a primary coil 1 aide and a secondary coil 2 side) of the side iron cores (the first side iron core 7 and the second side iron core 8), and the ignition coil is configured in such a way that a abolished portion is arranged at a high voltage side (a high-voltage terminal 6 side) of the ignition coil, so that a distance between the terminal 6, which is set at a high voltage when the ignition coil is operated, and the side iron cores, at which an electric potential is low, can be secured (a distance can be secured and the ignition coil is configured by using an insulating resin 14), so that an upsizing, which is not required, of the ignition coil can be avoided, and a reliability of the ignition coil can be secured.

In the scope of the present invention, it is possible that each of the embodiments is freely combined, or each of the embodiments is suitably modified or omitted.

### DESCRIPTION OF THE SYMBOLS

“1” is a primary coil; “2,” a secondary coil; “3,” a center iron core; “7,” a first side iron core; “8,” a second side iron core; “9” a magnet; “10,” elastomers; “11,” intervening components; “12,” a case; “14,” an insulating resin; “7a, 7b, 8a, and 8b,” separated surfaces.

1.-5. (canceled)

6. An ignition coil comprising:
a center iron core around which a primary coil and a secondary coil, which is coaxially provided at a circumference of the primary coil, are wound; and
side iron cores which surround a part of a circumference of the secondary coil so as to be arranged, and form a closed magnetic passage with the center iron core; in a state where the side iron cores are composed of a first side iron core and a second side iron core, in which portions, which are faced to a portion in an axis direction of the center iron core in a state where the primary coil and the secondary coil are sandwiched, are separated in an oblique direction with respect to an axis direction of the side iron cores, and a magnet is provided at a magnet holding portion which is formed between the first side iron core and the second side iron core, which are separated; wherein
facing portions, which are provided at end portions of separated surfaces of the first side iron core and at end portions of separated surfaces of the second side iron core, in a state where the magnet holding portion is formed by using the first side iron core and the second side iron core, and are faced at a surface which is vertical with respect to an axis direction of the side iron cores, and
intervening components, which are provided at the facing portions and are configured by using a non-magnetic material, are included; and
the intervening components have a thickness which is less than a distance between the separated surfaces of the first side iron core and the separated surfaces of the second side iron core.

7. The ignition coil as recited in claim 6, wherein the intervening components have a thickness which is greater than or equal to 50% of a distance between the separated surfaces of the first side iron core and the separated surfaces of the second side iron core.

8. The ignition coil as recited in claim 6, wherein the intervening components are configured by using an iron core cover which covers the side iron cores.

9. The ignition coil as recited in claim 7, wherein the intervening components are configured by using an iron core cover which covers the side iron cores.

10. The ignition coil as recited in claim 6, wherein the intervening components are provide at an outer side of the side iron cores.

11. The ignition coil as recited in claim 7, wherein the intervening components are provide at an outer side of the side iron cores.

12. The ignition coil as recited in claim 8, wherein the intervening components are provide at an outer side of the side iron cores.

13. The ignition coil as recited in claim 9, wherein the intervening components are provide at an outer side of the side iron cores.

14. The ignition coil as recited in claim 6, wherein a distance between vertical surfaces of the facing portions is greater than a thickness of the magnet.

15. The ignition coil as recited in claim 7, wherein a distance between vertical surfaces of the facing portions is greater than a thickness of the magnet.

16. The ignition coil as recited in claim 8, wherein a distance between vertical surfaces of the facing portions is greater than a thickness of the magnet.

17. The ignition coil as recited in claim 9, wherein a distance between vertical surfaces of the facing portions is greater than a thickness of the magnet.

18. The ignition coil as recited in claim 10, wherein a distance between vertical surfaces of the facing portions is greater than a thickness of the magnet.

19. The ignition coil as recited in claim 11, wherein a distance between vertical surfaces of the facing portions is greater than a thickness of the magnet.

20. The ignition coil as recited in claim 12, wherein a distance between vertical surfaces of the facing portions is greater than a thickness of the magnet.

21. The ignition coil as recited in claim 13, wherein a distance between vertical surfaces of the facing portions is greater than a thickness of the magnet.
